(19) United States
(12) Patent Application Publication
(10) Pub. No.: US 2016/0150512 A1
(43) Pub. Date: May 26, 2016

(54) Information Exchange Method, Base Station and Communication System

(71) Applicant: FUJITSU LIMITED, Kawasaki-shi (JP)

(72) Inventors: Yi ZHANG, Beijing (CN); Lei SONG, Beijing (CN); Hua ZHOU, Beijing (CN)

(73) Assignee: FUJITSU LIMITED, Kawasaki-shi (JP)

(21) Appl. No.: 15/013,450

(22) Filed: Feb. 2, 2016

Related U.S. Application Data
(63) Continuation of application No. PCT/CN2013/081189, filed on Aug. 9, 2013.

(51) Int. Cl. H04W 72/04; H04B 7/02

(52) U.S. Cl. CPC H04W 72/042; H04B 7/024; H04W 72/0446; H04W 92/20

(57) ABSTRACT

An information exchange method, a base station and a communication system. The information exchange method includes: transmitting, by a first base station to a second base station, resource coordination information for the coordinated multi-point transmission; or measurement coordination information for channel state information measurement; or resource management set coordination information; or spatial coordination information for multiple data stream transmission. Influence on CoMP transmission brought by non-ideal exchange latency may be reduced or eliminated.

### CROSS REFERENCE TO RELATED APPLICATIONS

This application is a continuation application of International Application PCT/CN2013/081189 filed on Aug. 9, 2013, the entire contents of which are incorporated herein by reference.

### TECHNICAL FIELD

The present disclosure relates to the field of communications, and in particular to an information exchange method, a base station and a communication system based on coordinated multipoint (CoMP) transmission of non-ideal latency.

### BACKGROUND

The scheme of coordinated multipoint transmission with ideal information exchange is introduced into an LTE-A system. It uses multiple base stations for coordinated transmission, and improves throughput of edge users of a cell. A conventional coordinated transmission scheme includes joint transmission, coordinated scheduling, coordinated beamforming, and transmission point selection technologies. The basic idea of them is avoidance of inter-cell interference, even changing interference of a neighboring cell into a useful signal.

All the supported coordinated transmission technologies in existing standards are based on ideal feedback, i.e. zero exchange latency and infinite feedback capacity. For example, such an assumption may be achieved by a network topology of a base station controller and multiple radio frequency heads.

However, it was found by the inventor that as the variety of the network topology, more and more cells shall be distributed in a macro base station. Non-ideal exchange latency will exist between macro base stations, between a macro base station and a small cell base station, and small cell base stations, etc., which are controlled by different eNBs. The inter-base-station non-ideal exchange latency will bring new problems to the CoMP transmission technology, thereby affecting performance of some transmission schemes.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Embodiments of the present disclosure provide an information exchange method, a base station and a communication system, with an object being to reduce or eliminate influence on CoMP transmission brought by non-ideal exchange latency by inter-base-station information exchange.

According to an aspect of the embodiments of the present disclosure, there is provided an information exchange method, applicable to a first base station and a second base station having non-ideal latency (or non-ideal backhaul) therebetween, wherein coordinated multi-point transmission being performed by a serving cell formed by the first base station and a coordinated cell formed by the second base station, the method including:

transmitting, by the first base station to the second base station, resource coordination information for the coordinated multi-point transmission, or measurement coordination information for channel state information measurement, or resource management set coordination information, or spatial coordination information for multiple data stream transmission.

According to another aspect of the embodiments of the present disclosure, there is provided an information exchange method, applicable to a first base station and a second base station having non-ideal latency therebetween, wherein coordinated multi-point transmission being performed by a serving cell formed by the first base station and a coordinated cell formed by the second base station, the method including:

receiving, by the second base station from the first base station, resource coordination information for the coordinated multi-point transmission, or measurement coordination information for channel state information measurement, or resource management set coordination information, or spatial coordination information for multiple data stream transmission.

According to a further aspect of the embodiments of the present disclosure, there is provided a base station, a serving cell formed by which and a coordinated cell formed by a second base station performing coordinated multi-point transmission, the base station and the second base station having non-ideal latency therebetween, and the base station including:

a transmitting unit configured to transmit resource coordination information for the coordinated multi-point transmission, or measurement coordination information for channel state information measurement, or resource management set coordination information, or spatial coordination information for multiple data stream transmission, to the second base station.

According to still another aspect of the embodiments of the present disclosure, there is provided a base station, a coordinated cell formed by which and a serving cell formed by a first base station performing coordinated multi-point transmission, the base station and the first base station having non-ideal latency therebetween, and the base station including:

a receiving unit configured to receive resource coordination information for the coordinated multi-point transmission, or measurement coordination information for channel state information measurement, or resource management set coordination information, or spatial coordination information for multiple data stream transmission, transmitted by the first base station.

According to still another aspect of the embodiments of the present disclosure, there is provided a communication system, including a first base station and a second base station, the first base station and the second base station having non-ideal latency therebetween, and a serving cell formed by the first base station and a coordinated cell formed by the second base station performing coordinated multi-point transmission;

wherein, the first base station transmits resource coordination information for the CoMP transmission, or measurement coordination information for channel state information measurement, or resource management set coordination information, or spatial coordination information for multiple data stream transmission, to the second base station.

According to still another aspect of the embodiments of the present disclosure, there is provided a computer-readable program, wherein when the program is executed in a base station, the program enables a computer to carry out the information exchange method as described above in the base station.

According to still another aspect of the embodiments of the present disclosure, there is provided a storage medium in which a computer-readable program is stored, wherein the computer-readable program enables a computer to carry out the information exchange method as described above in a base station.

An advantage of the embodiments of the present disclosure exists in that the first base station transmits resource coordination information for the CoMP transmission, or measurement coordination information for channel state information measurement, or resource management set coordination information, or spatial coordination information for multiple data stream transmission, to the second base station, thereby reducing or eliminating influence on CoMP transmission brought by non-ideal exchange latency.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the scopes of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of coordinated scheduling in CoMP transmission;

FIG. 2 is a schematic diagram of semi-static selection of transmission points in CoMP transmission:

FIG. 3 is a schematic diagram of coordinated beamforming in CoMP transmission;

FIG. 4 is a flowchart of the information exchange method of Embodiment 1 of the present disclosure;

FIG. 5 is anther flowchart of the information exchange method of Embodiment 1 of the present disclosure;

FIG. 6 is a flowchart of the information exchange method of Embodiment 2 of the present disclosure;

FIG. 7 is a schematic diagram of a multi-stream CoMP transmission scheme of Embodiment 2 of the present disclosure;

FIG. 8 is a flowchart of the information exchange method of Embodiment 3 of the present disclosure;

FIG. 9 is a flowchart of the information exchange method of Embodiment 4 of the present disclosure;

FIG. 10 is flowchart of the information exchange method of Embodiment 5 of the present disclosure;

FIG. 11 is a schematic diagram of a structure of the first base station of Embodiment 6 of the present disclosure;

FIG. 12 is a schematic diagram of a structure of the second base station of Embodiment 6 of the present disclosure; and

FIG. 13 is a schematic diagram of a structure of the communication system of Embodiment 6 of the present disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

Table 1 shows an example of an inter-base-station non-ideal particular exchange latency value. As shown in Table 1, non-ideal exchange latency may exist, such as between macro base stations, between a macro base station and a small cell base station, and small cell base stations, etc., which are controlled by different eNBs, and particular numerical values are related to transmission medium for the inter-base-station information exchange.

TABLE 1

| | | | | Priority |
|---|---|---|---|---|
| Backhaul | Latency | Throughout | | (1 is highest) |
| Optical fiber interface 1 | 10-30 ms | 10M-10 | Gbps | 1 |
| Optical fiber interface 2 | 5-10 ms | 100-1000 | Mbps | 2 |
| Optical fiber interface 3 | 2-5 ms | 50M-10 | Gbps | 1 |
| DSL interface | 15-60 ms | 10-100 | Mbps | 1 |
| Cable | 25-35 ms | 10-100 | Mbps | 2 |

| | | | |
|---|---|---|---|
| Radio | 5-35 ms | Typical | 1 |
| | | 10 Mbps-100 Mbps, | |
| | | up to Gbps | |

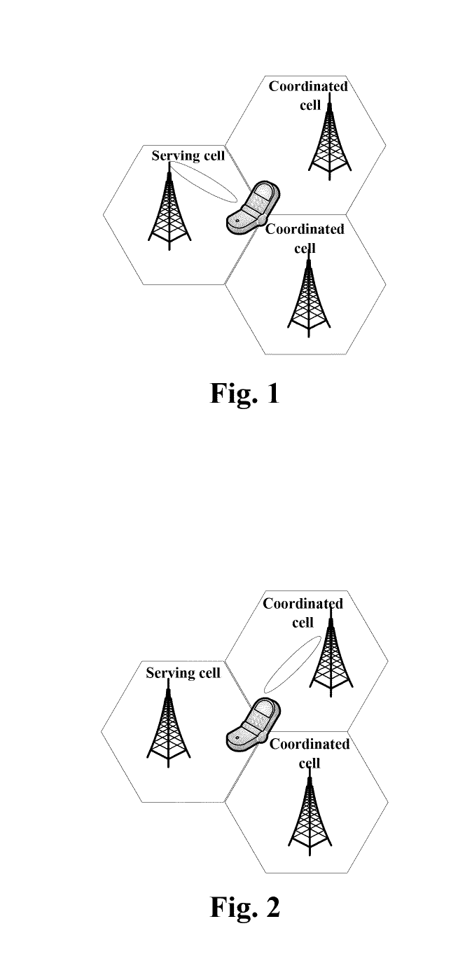

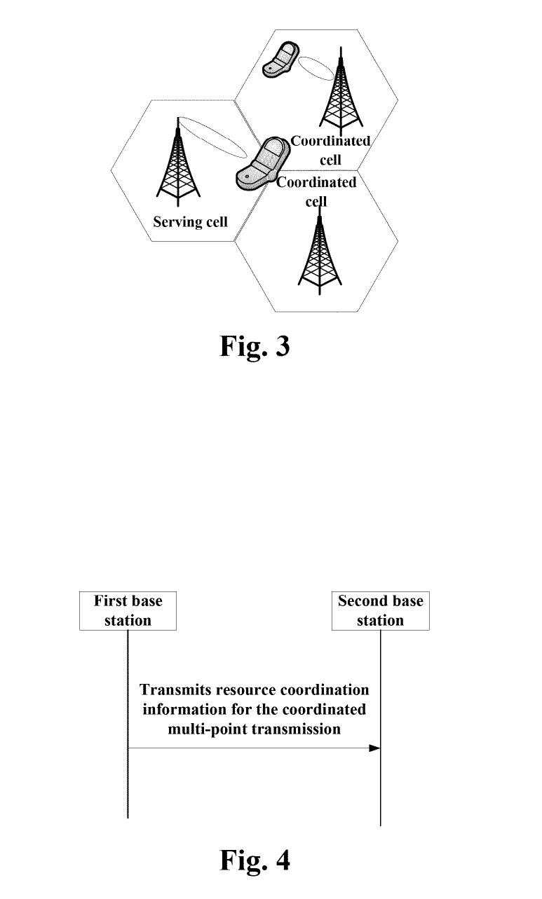

For the non-ideal exchange latency, three types of existing CoMP technologies have relatively good application expectation, which are coordinated scheduling, coordinated beamforming and semi-static transmission point selection. FIG. 1 is a schematic diagram of the coordinated scheduling. As show in FIG. 1, the coordinated scheduling reduces inter-UEs interference through inter-base-station semi-static scheduling and coordination. FIG. 2 is a schematic diagram of the semi-static transmission point selection. As show in FIG. 2, the semi-static transmission point selection selects a channel of better quality for transmission by semi-statically selecting transmission points. FIG. 3 is a schematic diagram of the coordinated beamforming. As show in FIG. 3, the coordinated beamforming reduces inter-cells interference by coordinating inter-cell beams.

In order to ensure the use of these coordinated transmission schemes, coordinated information needs to be exchanged between base stations. The present disclosure proposes exchanging coordinated information and designing corresponding signaling. On the other hand, these transmission schemes use a transmission point to transmit data to a UE, and do not fully use a channel for data transmission. The present disclosure proposes a method for performing multi-stream data transmission by using multiple transmission points. It should be noted that the CoMP transmission is described below taking only a serving cell and a coordinated cell as an example; however, the present disclosure is not limited thereto, and is applicable to scenarios there exist more than two cells.

### Embodiment 1

An embodiment of the present disclosure provides an information exchange method, applicable to a first base station and a second base station having non-ideal latency therebetween; a serving cell formed by the first base station and a coordinated cell formed by the second base station perform coordinated multi-point transmission.

FIG. 4 is a flowchart of the information exchange method of the embodiment of the present disclosure. As shown in FIG. 4, the method includes:

step 401: the first base station transmits resource coordination information for the coordinated multi-point transmission to the second base station.

In this embodiment, the resource coordination information may include information indicating a frequency domain resource, or may include information indicating a frequency domain resource and information indicating a time domain resource, or may include information indicating a frequency domain resource, information indicating a time domain resource and information indicating a spatial domain resource.

In this embodiment, the resource coordination information is exchanged via an X2 interface between the base stations. As an enhanced coordination technology, eCoMP is able to perform interference coordination in time domain, frequency domain and spatial domain, and is relatively flexible.

In an implementation, the resource coordination information may include the information indicating a frequency domain resource. In the frequency domain, part of physical resource blocks (PRBs) may be used for the CoMP transmission. That is, the serving cell (such as a cell 1) informs the coordinated cell (such as a cell 2) that a certain section of resources will schedule a UE of relatively intense interference, and the cell 2 mutes (or other effective interference coordination methods) this section of resources by employing a scheduling method as possible, so as to reduce interference on the UE of the cell 1.

In particular, the information indicating a frequency domain resource may include bitmap information based on a PRB. For example, which PRB may be scheduled and which PRB needs to be muted may be indicated by the bitmap, taking a PRB as a granularity. Or the information indicating a frequency domain resource may include bitmap information based on a resource block group (RBG), thereby reducing signaling payload of the X2. For example, which RBG may be scheduled and which RBG needs to be muted may be indicated by the bitmap, taking a RBG as a granularity.

However, the present disclosure is not limited thereto. For example, a method may be employed in which a total number of PRBs is indicated and K PRBs are selected from N PRBs. And a particular implementation may be determined according to an actual situation.

In this implementation, the frequency domain resource may not include an area of an enhanced physical downlink control channel (E-PDCCH) of the coordinated cell, that is, in the configuration of the interference coordination resources, in order to ensure validity of the interference coordination, the eCoMP transmission resources of the frequency domain needs to exclude the area of the E-PDCCH of the coordinated cell.

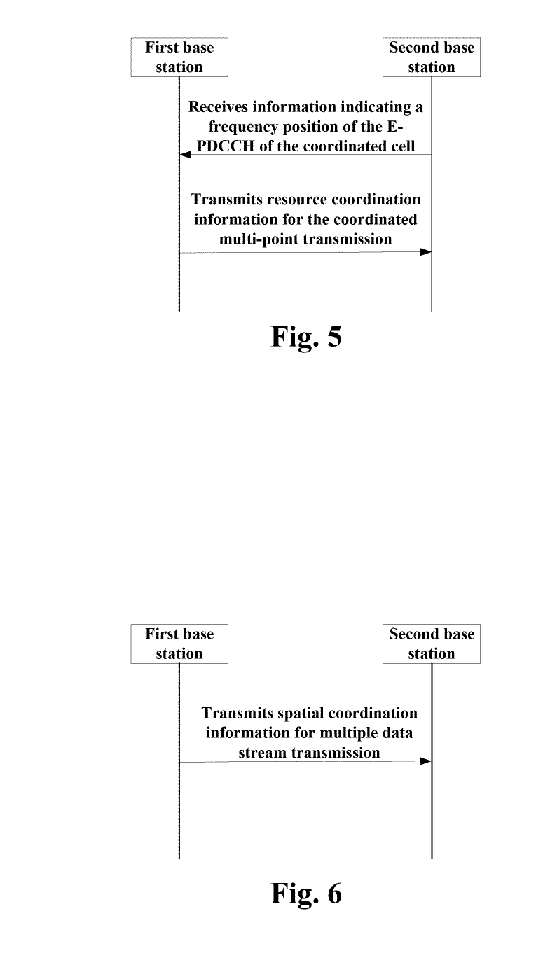

FIG. 5 is anther flowchart of the information exchange method of the embodiment of the present disclosure. As shown in FIG. 5, the method includes:

step 501: the first base station receives information indicating a frequency position of the E-PDCCH of the coordinated cell transmitted by the second base station; and

step 502: the first base station transmits the resource coordination information for the coordinated multi-point transmission to the second base station.

As shown in FIG. 5, the coordinated cell may inform the E-PDCCH information to the serving cell first, that is, the serving cell may acquire the frequency position of the E-PDCCH via signaling; and then the serving cell may configure the CoMP transmission resources of the frequency domain.

It should be noted that it may also transmit the information indicating a frequency position of the E-PDCCH of the coordinated cell in an implicit manner, that is, the first base station may obtain the frequency position of the E-PDCCH of the coordinated cell according to other information, which may be obtained from other information through deduction or calculation.

In another implementation, the resource coordination information may include information indicating a frequency domain resource and information indicating a time domain resource. In the time domain, in order to ensure reasonable allocation of resources for CoMP UE and non-CoMP UE, time domain CoMP subframe indication signaling may be proposed, that is, the CoMP transmission occurs only in specific subframes, a ratio of which being coordinated between the base stations.

In this implementation, the resource coordination information may further include information indicating a time domain resource. In particular, the information indicating a time domain resource may include bitmap information based on a subframe. An almost blank subframe (ABS) scheme is a time domain semi-static interference coordination scheme, which is employed in a heterogeneous network as a main interference coordination scheme.

For example, the manner of bitmap may be used to indicate subframes that may perform CoMP transmission in the time domain. In order to ensure transmission of uplink synchronization HARQ (Hybrid Automatic Repeat reQuest), the UE may perform transmission by using a non-CoMP operational mode in other subframes than the CoMP subframes. Based upon such an assumption, a period of this piece of signaling may be designed to be 10 ms, that is, it indicates whether subframes in a frame are semi-statically allocated with resources for CoMP transmission.

Table 2 is a schematic diagram of an example of time domain signaling indication of an eCoMP transmission subframe.

TABLE 2

| 0 | 1 | 2 | 3 | 4 | 5 | 6 | 7 | 8 | 9 |
|---|---|---|---|---|---|---|---|---|---|
| 0 | 1 | 1 | 1 | 0 | 0 | 1 | 1 | 1 | 0 |

0: subframes unavailable for eCoMP transmission
1: subframes available for eCoMP transmission

As shown in Table 2, if the CoMP UE can only be scheduled in the CoMP subframes, indication signaling similar to an ABS is used to indicate the subframes performing CoMP transmission in a period, the period being 40 ms for a frequency division duplexing (FDD) system, and being related to configuration of uplink and downlink subframes for a time division duplexing (TDD) system. For example, the period is 20 ms for configuration 1-5, 70 ms for configuration 0, and 60 ms for configuration 6. In this implementation, the information for indicating the frequency domain resource and the information for indicating the time domain resource may be joint, thereby forming joint time-frequency two-dimensional indication.

In particular, the information for indicating the frequency domain resource and the information for indicating the time domain resource may be transmitted respectively via different signaling. For example, frequency domain eCoMP resources of all the eCoMP subframes are identical, hence, the joint time-frequency two-dimensional indication may be decomposed into two sets of signaling: time domain indication and frequency domain indication. Therefore, a form of the signaling is relatively concise; however, the eCoMP frequency domain resources need to coordinate and consider frequency domain resources that can be used by the eCoMP subframes.

In particular, for each eCoMP subframe, the frequency domain resources that can be used may be given. Hence, the allocation is relatively flexible; however, signaling overhead is large, and may vary along with the number of the eCoMP subframes.

In particular, the time domain resource for the CoMP transmission may be divided into a first subframe overlapping with the subframe containing the E-PDCCH of the coordinated cell, and a second subframe not overlapping with the subframe containing the E-PDCCH of the coordinated cell; and the first base station may respectively correspond to the frequency domain resources for the CoMP transmission of the first subframe and the second frame by using different pieces of signaling, so as to transmit the resource coordination information.

For example, the eCoMP subframes are divided into two types, the first type subframes overlapping with the E-PDCCH subframes of the coordinated cell, and the second type of subframes not overlapping with the E-PDCCH subframes of the coordinated cell, and eCoMP resources used in the frequency domain and corresponding to these two types of subframes are respectively given by signaling.

In another implementation, the resource coordination information may include information indicating a frequency domain resource, information indicating a time domain resource and information indicating a spatial domain resource. Description in the above embodiment may be referred to for the frequency domain and time domain, and the spatial domain shall be described below.

In particular, the information indicating a spatial domain resource may include information indicating precoding matrix indicator (PMI) sets, so that the coordinated cell uses a corresponding PMI set in time-frequency resources. That is, multiple PMI sets may be divided, each PMI set corresponding to an area of a frequency resource performing the CoMP transmission in each subframe.

For example, in order to further support the spatial domain coordinated transmission technology, PMIs in an eCoMP area of the time-frequency resources may be divided into multiple sets, and the coordinated cell may only use a predefined PMI set in a corresponding resource. For example, 16 PMIs may be divided into 4 sets, and the eCoMP frequency resources of each subframe may also be divided into 4 areas, each area cyclically using the 4 PMI sets.

Of course, the greater the number of the PMI sets, the better of orthogonality of PMI; but continuity of available eCoMP resources will become poor, which affects effective scheduling of the frequency resources, and gains of frequency scheduling shall be reduced. Thus, a compromised scheme may be used, such as dividing into 2 or 4 sets. A client selects resources having a maximum signal to interference plus noise ratio to schedule according a PMI of a channel-matched neighboring cell.

It can be seen from the above embodiment that the first base station transmits resource coordination information for the CoMP transmission, or measurement coordination information for channel state information measurement, or resource management set coordination information, or spatial coordination information for multiple data stream transmission, to the second base station, thereby reducing or eliminating influence on CoMP transmission brought by non-ideal exchange latency.

### Embodiment 2

An embodiment of the present disclosure provides an information exchange method, applicable to a first base station and a second base station having non-ideal latency therebetween; a serving cell formed by the first base station and a coordinated cell formed by the second base station perform coordinated multi-point transmission.

FIG. 6 is a flowchart of the information exchange method of the embodiment of the present disclosure. As shown in FIG. 6, the method includes:

step 601: the first base station transmits spatial coordination information for multiple data stream transmission to the second base station, so that a first data stream is transmitted between the serving cell and a UE, and at the same time, a second data stream is transmitted between the coordinated cell and the UE.

In this embodiment, in order to further use spatial channel information, multiple base stations transmit different data streams to the UE at the same time. In order to reduce inter-stream interference of the UE, the spatial information is coordinated between the base stations. Following description is given taking only two data streams as an example.

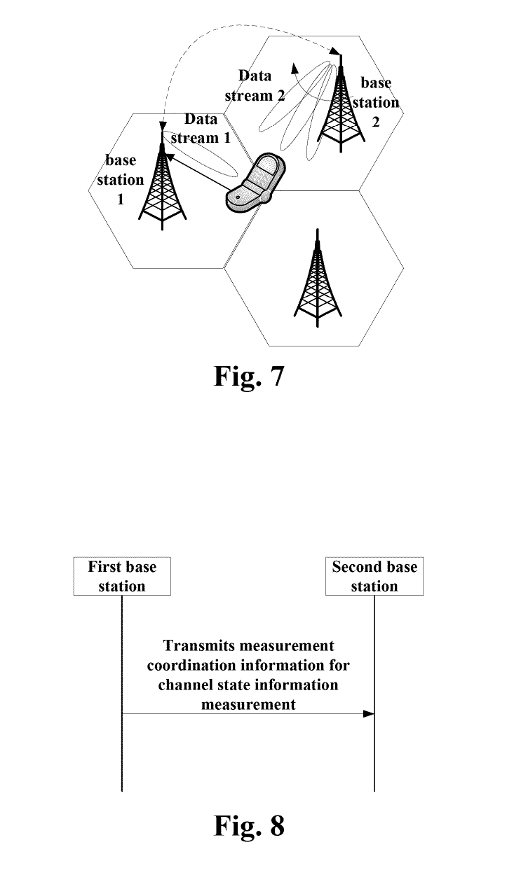

FIG. 7 is a schematic diagram of a multi-stream CoMP transmission scheme of the embodiment of the present disclosure. As shown in FIG. 7, there exists non-ideal latency between the base station 1 and base station 2. By the information exchange between the base station 1 and base station 2, a data stream 1 may be transmitted between the serving cell formed by the base station 1 and a UE, and at the same time, a data stream 2 may be transmitted between the coordinated cell formed by the base station 2 and the UE. Hence, different from the relevant art where only one transmission point may be employed to transmit data at the same time, the present disclosure may use multiple transmission points to transmit multi-stream data at the same time.

In this embodiment, the spatial coordination information may include PMI set information, the PMI set information may be acquired by a null space of a channel of the first data stream and a long-term spatial correlation matrix of the second data stream. Furthermore, the spatial coordination information may include semi-static scheduling information and fixed modulation and coding scheme (MCS) information.

For example, the UE performs closed-loop feedback of PMI/CQI (Channel Quality Indicator) for the channel of the base station 1, and feeds back feedback based on long-term spatial correlation matrix for the second data stream. The corresponding PMI may be PMI set (such as 2 or 4 PMIs), and the CQI may be average CQI feedback based on the PMI set, or may be a PMI set and open-loop CQI feedback.

In the transmission phase, the PMI used by the second base station is cyclically precoded in a PRB according to a PMI set exchanged by the X2 and based on UE feedback. The information exchanged between the base stations includes semi-static scheduling information, fixed MCS information and PMI set information. The PMI set is acquired by the null space of the channel of the data stream 1 and the long-term spatial correlation matrix of the data stream 2; that is, a projection of a feature space of the long-term spatial correlation matrix in the null space of the channel of the data stream 1.

It can be seen from the above embodiment that by the information exchange between the base stations, the first data stream may be transmitted between the serving cell and the UE, and at the same time, the second data stream may be transmitted between the coordinated cell and the UE. Hence, spatial channel information may further be used, thereby reducing or eliminating influence on CoMP transmission brought by non-ideal exchange latency.

### Embodiment 3

An embodiment of the present disclosure provides an information exchange method, applicable to a first base station and a second base station having non-ideal latency therebetween; a serving cell formed by the first base station and a coordinated cell formed by the second base station perform coordinated multi-point transmission.

FIG. 8 is a flowchart of the information exchange method of the embodiment of the present disclosure. As shown in FIG. 8, the method includes:

step 801: the first base station transmits measurement coordination information for channel state information measurement to the second base station.

In this embodiment, in order to ensure effective CoMP transmission, the UE end needs to perform measurement and report of channel state information (CSI). The measurement is usually performed by the UE end on a CSI process, which may include two parts, NZP-CSI-RS (NZP, non-zero power) and ZP-CSI-RS (ZP, zero power); the former part corresponds to measurement of a channel part, and the latter part corresponds to measurement of an interference part. And the information may be independently configured for different UE.

In order to reduce inter-base-station information exchange, unified exchange information for a cell may be used for coordination information of any two base stations. And the base station ends coordinate these two parts of reference signals according to the exchange information to perform CSI measurement.

In an implementation, the measurement coordination information may include configuration information of the NZP-CSI-RS. In particular, the configuration information of the NZP-CSI-RS may include one piece of the following information or a combination thereof: the number of antenna ports of a channel state information reference signal (CSI-RS), time-frequency resource configuration information of a CSI-RS in a resource block, time domain subframe configuration information of a CSI-RS, virtual cell ID of a CSI-RS sequence, and power ratio information of a CSI-RS relative to a physical downlink shared channel (PDSCH). A serving base station (such as the first base station) may configure appropriate configuration information on NZP-CSI-RS, so as to measure the channel part (for example, it is effective corresponding to a coordinated beamforming scheme).

In another implementation, the measurement coordination information may include configuration information of the ZP-CSI-RS. The ZP-CSI-RS may be divided into two types, a common ZP-CSI-RS and anther ZP-CSI-RS. For example, two cells in resources of the common ZP-CSI-RS are both muted, and do not perform data transmission; and in resources of the other ZP-CSI-RS, a present cell is muted, and a coordinated cell performs data transmission.

In particular, for the ZP-CSI-RS, a base station needs to coordinate the common ZP-CSI-RS and the other ZP-CSI-RS, and the UE measures interference in an interference coordination state by using the common ZP-CSI-RS; the coordinated cell transmits data at the other ZP-CSI-RS, and the LIE measures interference in an interference-free coordination state by using the other ZP-CSI-RS. The UE obtains a needed interference measurement result in a corresponding measurement resource according to coordination of interference measurement resources between the base stations.

For example, the serving base station notifies the coordinated base station of configuration of a ZP-CSI-RS and another ZP-CSI-RS, and the coordinated base station configures a ZP-CSI-RS at a position corresponding to the common ZP-CSI-RS and transmits data information at a position corresponding to the other ZP-CSI-RS, thereby ensuring correct measurement of the channel interference information by the UE.

In this implementation, for the two types of exchange signaling of ZP-CSI-RS, the common ZP-CSI-RS and other ZP-CSI-RS may correspond to 4-port CSI-RS configuration, such as using identical subframe configuration, i.e. identical subframe periods and offsets. ZP-CSI-RSs are distributed in each PRB of a full band, and resources used in each time-frequency resource block are as shown in Table 3 and Table 4, which respectively show results of normal cyclic prefix subframes and extended cyclic prefix subframes.

TABLE 3
Mapping from CSI-RS configuration to (k′, l′) for normal CP

Number of
CSI-RS configured
4 ports

| | CSI-RS configuration | (k′, l′) | nₛ mod 2 |
|---|---|---|---|
| Frame | 0 | (11, 4) | 0 |
| structures | 1 | (9, 4) | 0 |
| types 1 and 2 | 2 | (10, 4) | 1 |
| | 3 | (9, 4) | 1 |
| | 4 | (5, 4) | 0 |
| | 5 | (3, 4) | 0 |
| | 6 | (4, 4) | 1 |
| | 7 | (3, 4) | 1 |
| | 8 | | |
| | 9 | | |
| | 10 | | |
| | 11 | | |
| | 12 | | |
| | 13 | | |
| | 14 | | |
| | 15 | | |
| Frame | 16 | (11, 1) | 1 |
| structure | 17 | (10, 1) | 1 |
| type 2 only | 18 | (9, 1) | 1 |
| | 19 | (5, 1) | 1 |
| | 20 | (4, 1) | 1 |
| | 21 | (3, 1) | 1 |
| | 22 | | |
| | 23 | | |
| | 24 | | |
| | 25 | | |
| | 26 | | |
| | 27 | | |

As shown in Table 3, for the normal CP subframes, 16 bits may be used to indicate the time-frequency resource positions, respectively.

TABLE 4
Mapping from CSI-RS configuration to (k′, l′) for extended CP

| | |
|---|---|
| | Number of |
| | CSI-RS configured |
| CSI-RS | 4 ports |

| | configuration | (k′, l′) | nₛ mod 2 |
|---|---|---|---|
| Frame | 0 | (11, 4) | 0 |
| structures | 1 | (9, 4) | 0 |
| types 1 and 2 | 2 | (10, 4) | 1 |
| | 3 | (9, 4) | 1 |
| | 4 | (5, 4) | 0 |
| | 5 | (3, 4) | 0 |
| | 6 | (4, 4) | 1 |
| | 7 | (3, 4) | 1 |
| | 8 | | |
| | 9 | | |
| | 10 | | |
| | 11 | | |
| | 12 | | |
| | 13 | | |
| | 14 | | |
| | 15 | | |
| Frame | 16 | (11, 1) | 1 |
| structure | 17 | (10, 1) | 1 |
| type 2 only | 18 | (9, 1) | 1 |
| | 19 | (5, 1) | 1 |
| | 20 | (4, 1) | 1 |
| | 21 | (3, 1) | 1 |
| | 23 | | |
| | 24 | | |
| | 25 | | |
| | 26 | | |
| | 27 | | |

As shown in Table 4, for extended CP subframes, 16 bits may also be used to indicate the time-frequency resource positions respectively.

Furthermore, the time-frequency resource positions of the common ZP-CSI-RS and the other ZP-CSI-RS may also be indicated by using 16 bits, that is, two different pieces of 16-bit signaling are used to indicate. Or they may be indicated by tri-state bitmap information; one state denotes no ZP-CSI-RS, another state denotes the common ZP-CSI-RS, and the last state denotes the other ZP-CSI-RS. For example, 0 denotes no ZP-CSI-RS, 1 denotes the common ZP-CSI-RS, that is, the both cells are muted and do not transmit data, and 2 denotes the other ZP-CSI-RS, that is, the serving cell is muted, and the coordinated cell transmits data.

Furthermore, it is also be implemented in more than two cells, and a signaling indication scheme of multi-state bitmaps may be used. For example, following description is given taking three cells, a serving cell, a coordinated cell 1 and a coordinated cell 2, as an example. 0 denotes no ZP-CSI-RS, that is, the serving cell transmits data, and the other cells need no special measurement coordination scheme; 1 denotes the common ZP-CSI-RS, that is, all the three cells are muted and do not transmit data; 2 denotes partial common ZP-CSI-RS, that is, the coordinated cell 1 is muted, and the coordinated cell 2 transmits data; and 3 denotes the other ZP-CSI-RS, that is, the serving cell is muted, and both the coordinated cell 1 and the coordinated cell 2 transmit data.

It should be noted that how to indicate is only illustrated above. However, the present disclosure is not limited thereto, and a particular implementation may be determined according to an actual situation.

In another implementation, the measurement coordination information may include configuration information of ZP-CSI-RS. In an indicated ZP-CSI-RS resource, the both cells are muted, and do not transmit data. Four-port CSI-RS configuration signaling, including subframe configuration information and 16-bit resource indication information, may be reused in a particular signaling design. For example, 0 denotes a corresponding resource of the serving cell, which is not a ZP-CSI-RS resource; 1 denotes a corresponding resource of the serving cell, which is a ZP-CSI-RS resource; and it is expected that the coordinated cell is muted in the ZP-CSI-RS resource to which “1” corresponds.

It can be seen from the above embodiment that the first base station transmits measurement coordination information for channel state information measurement to the second base station, thereby reducing or eliminating influence on CoMP transmission brought by non-ideal exchange latency.

### Embodiment 4

An embodiment of the present disclosure provides an information exchange method, applicable to a first base station and a second base station having non-ideal latency therebetween; a serving cell formed by the first base station and a coordinated cell formed by the second base station perform coordinated multi-point transmission.

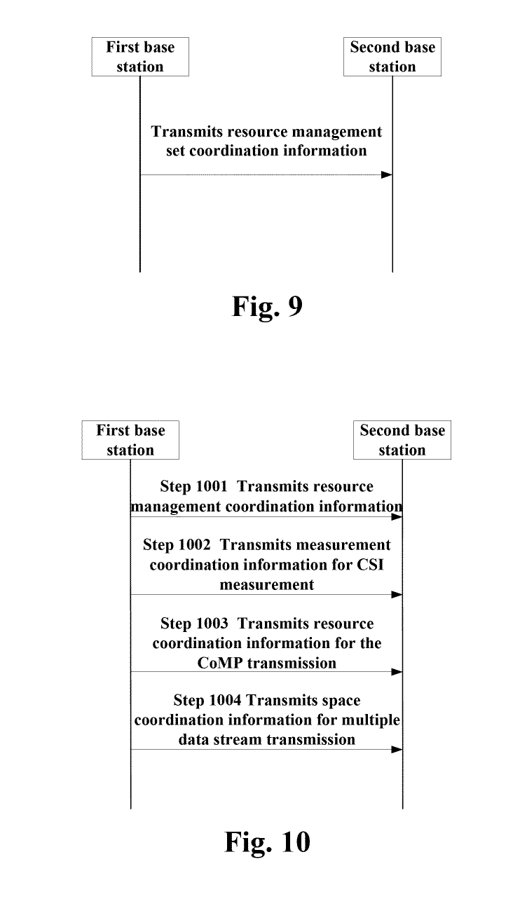

FIG. 9 is a flowchart of the information exchange method of the embodiment of the present disclosure. As shown in FIG. 9, the method includes:

step 901: the first base station transmits resource management set coordination information to the second base station.

In this embodiment, a CoMP resource management set may be determined by measurement of a CSI-RS, a common reference signal (CRS), or a sounding reference signal (SRS), and an eNB may configure a CoMP cooperating set according to a measurement result. A resource management set coordination information may include configuration information on the CSI-RS, or configuration information on the CRS, or configuration information on the SRS.

In particular, if a measurement set is managed by using a measurement result of the CSI-RS, the configuration information on the CSI-RS needs to be exchanged between base stations. The configuration information on the CSI-RS may include one piece of the following information or a combination thereof: the number of antenna ports of a CSI-RS, time-frequency resource configuration information of a CSI-RS in a resource block, time domain subframe configuration information of a CSI-RS, virtual cell ID of a CSI-RS sequence, and power ratio information of a CSI-RS relative to a PDSCH.

In particular, if the measurement set is managed by using a measurement result of the SRS, the base station needs to inform the coordinated base station of such information as resources of the SRS (such as time domain position bandwidth configuration, and subframe configuration), and sequences, etc.

In particular, if the measurement set is managed by using a measurement result of the CRS, the base station needs to inform the coordinated base station of the number of ports of the CRS needing to be measured by the UE, sequences (cell-ID, an SFN (System Frame Number)), MBSFN (Multimedia Broadcast Single Frequency Network) configuration, even a system bandwidth of a measured cell.

It can be seen from the above embodiment that the first base station transmits resource management set coordination information to the second base station, thereby reducing or eliminating influence on CoMP transmission brought by non-ideal exchange latency.

### Embodiment 5

An embodiment of the present disclosure provides an information exchange method, applicable to a first base station and a second base station having non-ideal latency therebetween; a serving cell formed by the first base station and a coordinated cell formed by the second base station perform coordinated multi-point transmission.

In particular implementation of the present disclosure, as described in any one of embodiments 1-4, only one piece of the following information may be transmitted: resource coordination information for the CoMP transmission, or spatial coordination information for multiple data stream transmission, or measurement coordination information for CSI measurement, or resource management set coordination information. Furthermore, more or all of the above information may also be transmitted, as described in this embodiment. This embodiment is based on embodiments 1-4, with identical contents being no going to be described any further.

FIG. 10 is a flowchart of the information exchange method of the embodiment of the present disclosure. As shown in FIG. 10, the method includes:

step 1001: the first base station transmits resource management set coordination information to the second base station;

step 1002: the first base station transmits measurement coordination information for CSI measurement to the second base station;

step 1003: the first base station transmits resource coordination information for the CoMP transmission to the second base station.

As shown in FIG. 10, the method may further include:

step 1004: the first base station transmits spatial coordination information for multiple data stream transmission to the second base station, so that a first data stream is transmitted between the serving cell and a UE, and at the same time, a second data stream is transmitted between the coordinated cell and the UE.

In this embodiment, an order of execution of these steps is not limited thereto, and may be determined according to an actual situation. Furthermore, only one or more of the above steps may be executed, and a particular step may be determined according to an actual situation, and the present disclosure is not limited thereto.

It can be seen from the above embodiment that the first base station transmits one piece of the following information or a combination thereof to the second base station: resource management set coordination information, measurement coordination information for CSI measurement, resource coordination information for the CoMP transmission and spatial coordination information for multiple data stream transmission, thereby reducing or eliminating influence on CoMP transmission brought by non-ideal exchange latency.

### Embodiment 6

An embodiment of the present disclosure provides a base station, a serving cell formed by which and a coordinated cell formed by a second base station performing coordinated multi-point transmission, the base station and the second base station having non-ideal latency therebetween, with contents identical to those in embodiments 1-5 being not going to be described any further.

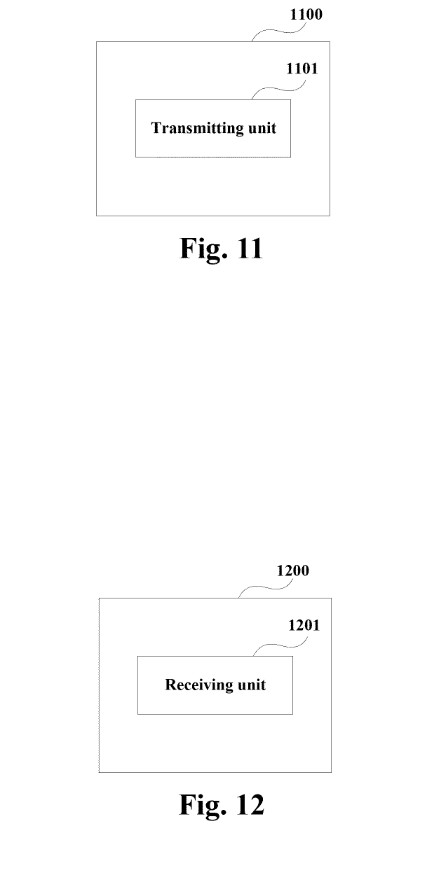

FIG. 11 is a schematic diagram of a structure of a first base station of the embodiment of the present disclosure. As shown in FIG. 11, the base station 1100 (i.e. the first base station) includes a transmitting unit 1101. Other parts of the base station 1100 are not shown, and the relevant art may be referred to.

The transmitting unit 1101 is configured to transmit resource coordination information for the coordinated multi-point transmission, or measurement coordination information for channel state information measurement, or resource management set coordination information, or spatial coordination information for multiple data stream transmission, to the second base station.

An embodiment of the present disclosure further provides a base station, a coordinated cell formed by which and a serving cell formed by a first base station performing coordinated multi-point transmission, the base station and the first base station having non-ideal latency therebetween.

FIG. 12 is a schematic diagram of a structure of the second base station of the embodiment of the present disclosure. As shown in FIG. 12, the base station 1200 (i.e. the second base station) may include a receiving unit 1201. Other parts of the base station 1200 are not shown, and the relevant art may be referred to.

The receiving unit 1201 is configured to receive resource coordination information for the coordinated multi-point transmission, or measurement coordination information for channel state information measurement, or resource management set coordination information, or spatial coordination information for multiple data stream transmission, transmitted by the first base station.

An embodiment of the present disclosure further provides a communication system, including a first base station and a second base station, the first base station and the second base station having non-ideal latency therebetween, and a serving cell formed by the first base station and a coordinated cell formed by the second base station performing coordinated multi-point transmission.

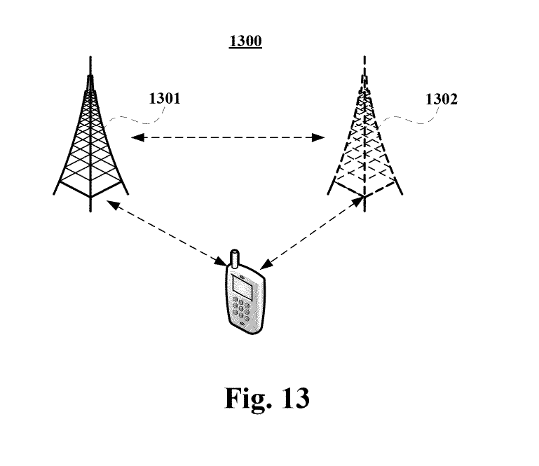

FIG. 13 is a schematic diagram of a structure of the communication system of the embodiment of the present disclosure. As shown in FIG. 13, the communication system 1300 includes a first base station 1301, a second base station 1302 and a UE.

The first base station 1301 is configured to transmit resource coordination information for the coordinated multi-point transmission, or measurement coordination information for channel state information measurement, or resource management set coordination information, or spatial coordination information for multiple data stream transmission, to the second base station 1302.

An embodiment of the present disclosure further provides a computer-readable program, wherein when the program is executed in a base station, the program enables a computer to carry out the information exchange method as described in embodiments 1-5 in the base station.

An embodiment of the present disclosure further provides a storage medium in which a computer-readable program is stored, wherein the computer-readable program enables a computer to carry out the information exchange method as described in embodiments 1-5 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in Figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

What is claimed is:

1. A base station, a serving cell formed by which and a coordinated cell formed by a second base station performing coordinated multi-point transmission, the base station and the second base station having non-ideal latency therebetween, and the base station comprising:
a transmitting unit configured to transmit resource coordination information for the coordinated multi-point transmission, or measurement coordination information for channel state information measurement, or resource management set coordination information, or spatial coordination information for multiple data stream transmission, to the second base station.

2. The base station according to claim 1, wherein the resource coordination information comprises information indicating a frequency domain resource, or information indicating a frequency domain resource and information indicating a time domain resource, or information indicating a frequency domain resource, information indicating a time domain resource and information indicating a spatial domain resource.

3. The base station according to claim 2, wherein the information indicating the frequency domain resource comprises bitmap information based on a physical resource block, or comprises bitmap information based on a resource block group;
the information indicating the time domain resource comprises bitmap information based on a subframe.

4. The base station according to claim 2, wherein the frequency domain resource does not comprise an area of an enhanced physical downlink control channel of the coordinated cell;
the base station is further configured to receive information indicating a frequency position of the enhanced physical downlink control channel of the coordinated cell transmitted by the second base station.

5. The base station according to claim 2, wherein the information indicating the time domain resource is used to indicate the subframe performing coordinated multi-point transmission in a period,
the period being 40 ms for a frequency division duplexing system, and
being related to configuration of uplink and downlink subframes for a time division duplexing system, the period being 20 ms for configuration 1-5, 70 ms for configuration 0, and 60 ms for configuration 6.

6. The base station according to claim 2, wherein the information for indicating the frequency domain resource and the information for indicating the time domain resource are transmitted respectively via different signaling.

7. The base station according to claim 2, wherein the base station is further configured to:
divide the time domain resource for coordinated multi-point transmission into a first subframe set overlapping with subframes containing an enhanced physical downlink control channel of the coordinated cell, and a second subframe set not overlapping with subframes containing the enhanced physical downlink control channel of the coordinated cell; and
correspond respectively to the frequency domain resources for coordinated multi-point transmission in the first subframe set and the second subframe set by using different pieces of signaling, so as to transmit the resource coordination information.

8. The base station according to claim 2, wherein the information indicating the spatial domain resource comprises information indicating precoding matrix indicator set, so that the coordinated cell uses a corresponding precoding matrix indicator set in resources.

9. The base station according to claim 8, wherein the base station is further configured to:
divide precoding matrix indicator into multiple sets; and each of multiple precoding matrix indicator sets corresponds to an area of the frequency domain resource for coordinated multi-point transmission in a subframe.

10. The base station according to claim 9, wherein the resources comprise time-frequency resources or frequency domain resources, and the frequency domain resources are consecutive.

11. The base station according to claim 1, wherein the measurement coordination information comprises configuration information on a ZP-CSI-RS and/or configuration information on an NZP-CSI-RS;
the ZP-CSI-RS comprises a common ZP-CSI-RS or another ZP-CSI-RS.

12. The base station according to claim 11, wherein the configuration information on an NZP-CSI-RS comprises one piece of the following information or a combination thereof: the number of antenna ports of a channel state information reference signal, time-frequency resource configuration information of a channel state information reference signal in a resource block, time domain subframe configuration information of a channel state information reference signal, virtual cell ID of a channel state information reference signal sequence, and power ratio information of a channel state information reference signal relative to a physical downlink shared channel.

13. The base station according to claim 11, wherein time-frequency resource positions of the common ZP-CSI-RS and the another ZP-CSI-RS are indicated by 16 bits, respectively; or indicated by tri-state bitmap information, wherein one state denotes no ZP-CSI-RS, another state denotes the common ZP-CSI-RS, and the last state denotes the another ZP-CSI-RS.

14. The base station according to claim 1, wherein the resource management set coordination information comprises configuration information on a channel state information reference signal, or configuration information on a common reference signal, or configuration information on a sounding reference signal.

15. The base station according to claim 14, wherein the configuration information on a channel state information reference signal comprises one piece of the following information or a combination thereof: the number of antenna ports of a channel state information reference signal, time-frequency resource configuration information of a channel state information reference signal in a resource block, time domain subframe configuration information of a channel state information reference signal, virtual cell ID of a channel state information reference signal sequence, and power ratio information of a channel state information reference signal relative to a physical downlink shared channel.

16. The base station according to claim 1, wherein the spatial coordination information comprises precoding matrix indicator set information, the precoding matrix indicator set information being acquired by a null space of a channel of the first data stream and a long-term spatial correlation matrix of the second data stream.

17. The base station according to claim 16, wherein the spatial coordination information further comprises semi-static scheduling information and fixed modulation and coding scheme information;
the precoding matrix indicator set is used by the coordinated cell for cyclically precoding resource blocks.

18. The base station according to claim 16, wherein closed-loop feedback is performed by the UE for the channel of the first data stream, and open-loop feedback is performed by the UE for the channel of the second data stream:
the open-loop feedback comprises: feedback of an average channel quality indicator based on the precoding matrix indicator set.

19. A base station, a coordinated cell formed by which and a serving cell formed by a first base station performing coordinated multi-point transmission, the base station and the first base station having non-ideal latency therebetween, and the base station comprising:
a receiving unit configured to receive resource coordination information for the coordinated multi-point transmission, or measurement coordination information for channel state information measurement, or resource management set coordination information, or spatial coordination information for multiple data stream transmission, transmitted by the first base station.

20. A communication system, comprising a first base station and a second base station, the first base station and the second base station having non-ideal latency therebetween, and a serving cell formed by the first base station and a coordinated cell formed by the second base station performing coordinated multi-point transmission;
wherein, the first base station transmits resource coordination information for the coordinated multi-point transmission, or measurement coordination information for channel state information measurement, or resource management set coordination information, or spatial coordination information for multiple data stream transmission, to the second base station.
